(19) United States
(12) Patent Application Publication
(10) Pub. No.: US 2006/0168933 A1
(43) Pub. Date: Aug. 3, 2006

(54) Blade for rotary cutting machine

(76) Inventor: Robert G. Hill JR., Florence, KY (US)

Correspondence Address: Carl E. Knochelmann, Jr., 526 Greenup Street, Covington, KY, 41011, US

(21) Appl. No.: 11/047,503

(22) Filed: Feb. 1, 2005

(51) Int. Cl. A01D 34/73

(52) U.S. Cl. 56/295

(57) ABSTRACT

A blade with an easily and economically maintainable cutting edge for cutting vegetation in a rotary cutting machine such as in a lawnmower or brush cutter is described. A blade assembly is comprised of an elongated blade with replaceable inserts that enhance the cutting and mulching functions of the rotary cutting machine. The replaceable inserts are installed at a skew angle and provide an easily maintainable cutting edge that has geometrically shaped fingers that provide both a chopping and a slicing action that enhances the cutting performance of the blade assembly. Mulching blades re-cut the vegetation severed by the shaped fingers into smaller pieces before the vegetation exits the rotary cutting machine to minimize or eliminate the need to pick up the cut vegetation while maintaining an aesthetically pleasing final cut. Each replaceable insert has a safety connector that prevents the dislodging of the replaceable insert from the blade assembly during operation in the event that fasteners fail during operation. An integral blade is also anticipated that has geometrically shaped fingers installed at a skew angle that provide both a chopping and a slicing action.

### BACKGROUND OF THE INVENTION

1. Field of the Invention

This invention relates, in general, to blades for rotary cutting machines such as those used to maintain lawns and to cut various types of vegetation found in yards and fields. The ease with which the sharpness of the blade can be maintained is determined by the effort required to replace or remove the blade for sharpening. A cutting edge that provides both a chopping and slicing action while cutting the vegetation ensures a cleaner and more accurate cut. A blade that provides quick and economic maintenance of a sharp cutting edge in a rotary cutting machine with superior performance is provided in the present invention.

2. Description of the Prior Art

Maintaining sharp cutting edges in a rotary cutting machine is currently a time consuming and inefficient process that usually requires the removal of the entire blade from the mower. In both home and commercial mowing applications, the maintenance of a sharp cutting edge is very important due to the demand for a fast and aesthetically pleasing final cut which can be a major cost of operation. Typically, mowers utilize either a blade with a cutting edge at each end or two or more blades on a blade platform, each with a single cutting edge at one end, with three or more blades being very common. Dull blades cause the vegetation being cut to be broken off as opposed to being cut which effects the efficient operation of the mower and produces an unevenly and ununiformly cut lawn that frequently results in unsightly brown edges. The maintenance of blades with sharp cutting edges is important to achieving the desired result of an evenly cut lawn or field without brown edges.

In order to maintain blades with a sharp cutting edge, a dull blade, in a prior art rotary cutting machine, must be removed and either sharpened by one of various well known methods or replaced with a new blade. Blade removal and sharpening is the most typical method of maintaining a sharp cutting edge. Problems can be encountered if the cutting edge is incorrectly sharpened. The cutting properties, balance, and hardness of the cutting edge, and safety could be dramatically affected by an improperly sharpened cutting edge. The typical end result of sharpening a case hardened blade is that the hardened surface of the cutting edge is removed, exposing softer metal that dulls more quickly than the original hardened surface, and the balance of the blade is upset. An improperly balanced blade increases the wear on the mower and can cause a greatly increased vibration which could cause failure of the metal in the blade. In a typical commercial mower, blade rpm is generally between 2000 to 4000 rpm. A broken blade could become dislodged due to vibration induced stress and possibly impact the operator or a bystander at a high velocity causing injury or damage.

The process of removal, sharpening, balancing and installing a set of three blades in a typical commercial rotary cutting machine can take 30 minutes or more. For a commercial operator, with a fleet of mowing machines, a significant amount of human resources can be saved by providing a safe, rugged, inexpensive, replaceable alternative to the method of maintaining blades with sharp cutting edges commonly in use today.

Complete replacement of the blade is expensive and time consuming. In prior art blades, some have been described with replaceable cutting edges. To date, none have gained market availability or acceptance due to various negative attributes such as lack of operator safety, poor cutting performance, manufacturing complexity, dangerous engineering defects (such as the replaceable cutting edge separating from the main blade due to fastener failure), and a high cost to produce. No prior art replaceable cutting edge blade has addressed the risk of a separation of the replaceable cutting edge element from the main blade in the event of fastener failure or disengagement during operation.

Accordingly, it is an object of this invention to provide an effective blade for various applications of a rotary cutting machine that is inexpensive and easy to maintain which employs an effective system for easy alignment and secure retention during operation and employs an effective system for cutting vegetation that provides an aesthetically desirable final cut.

### SUMMARY OF THE INVENTION

In carrying out this invention, in one form thereof, a blade for cutting vegetation, such as grass in a typical lawn or a varied spectrum of vegetation in a field, by a rotary cutting machine is anticipated. The new features of the blade of the present invention are anticipated in the form of both a blade assembly or an integral blade. The blade assembly for cutting vegetation in a rotary cutting machine has an insert holder that is an elongated blade with two blade ends and has a longitudinal axis that extends beyond the length of the elongated blade. The elongated blade is adapted to rotate about a central axis that passes through the longitudinal axis, usually at a right angle. One or more insert ends are located at one or more of the blade ends, wherein each of the insert ends is configured to receive a replaceable insert. The elongated blade, in one embodiment of the invention, has a replaceable insert at only one of its blade ends. In this case, the elongated blade is attached to a blade platform at the blade end that does not have an insert end. Usually there are multiple elongated blades spaced around the circumference of the blade platform as the blade platform rotates about a central axis passing through the center of the blade platform and intersects each longitudinal axis.

In the embodiment of the invention where the elongated blade has a replaceable insert attached at each of two insert ends, the central axis of rotation is located at the center of the elongated blade. In all embodiments of the present invention, maintaining balance of the elongated blade assembly or blade platform is anticipated. Each of the one or more insert ends have a top surface facing away from the vegetation, a bottom surface facing toward the vegetation, a leading edge that is formed to receive the replaceable insert; a trailing edge; one or more insert end fasteners for attaching the replaceable insert to the one or more insert ends; and a safety connector. The safety connector is included to ensure that the replaceable insert can not come loose from the elongated blade during operation. The safety connector functions by centrifugal force of the spinning elongated blade during operation to maintain the integrity of the blade assembly. In the event that the insert end fasteners that connect the replaceable insert to the insert end fails during operation, the centrifugal force created by the spinning elongated blade activates the safety connector to prevent the replaceable insert from dislodging from the insert end.

The replaceable insert is a flattened blade adapted to mate with any one or more of the insert ends on the elongated blade. Each replaceable insert has a bottom side; a top side; a rear facing edge; a front facing edge for cutting vegetation; an insert safety connector that engages the safety connector on the one or more insert ends of the elongated blade; and one or more insert fasteners that matingly engages the one or more insert end fasteners on each of the one or more insert ends in order to connect the replaceable insert to each insert end. The replaceable insert can be configured to be mounted either on the top or on the bottom of each insert end. The bottom mount location is shown as a preferred embodiment in the attached drawings, but either method of installation is anticipated herein.

The integral blade for cutting vegetation in a rotary cutting machine is an elongated blade with two blade ends and a longitudinal axis extending beyond the length of the elongated blade and is adapted to rotate about a central axis that passes through the longitudinal axis, usually at a right angle. One or more blade ends is formed into a cutting end. Each of the one or more cutting ends has a top surface facing away from the vegetation; a bottom surface facing toward the vegetation; a front facing edge for cutting the vegetation; and a trailing edge. The front facing edge for the integral blade has all of the features of the shaped leading edge for the replaceable insert described below. In an alternate embodiment, the integral blade has a cutting end at only one of its blade ends. In this case, the integral blade is attached to a blade platform at the blade end that does not have a cutting end. Usually there are integral blades spaced around the circumference of the blade platform. The blade platform rotates about a central axis passing through the center of the blade platform and intersects each longitudinal axis. In the case where the integral blade has a cutting end at each of two blade ends, the central axis of rotation is located at the center of the elongated blade. In both embodiments of one or two cutting ends on an integral blade, maintaining balance of the integral blade or blade platform is anticipated to minimize vibration while rotating during operation.

The front facing edge of the replaceable insert and of the integral blade is a shaped leading edge that is tailored specifically to the vegetation to be cut. The shaped leading edge has a plurality of geometric fingers along the shaped leading edge. Each geometric finger has a spacing distance, S, and each has a depth, D. A shape ratio is defined by dividing the depth, D, by the spacing distance, S. The shape ratio is held to values between zero (0.00) and one (1.00) to maximize cutting efficiency and effectiveness. In selecting a shape ratio for a particular application, spacing distance should be larger than two times the diameter of the largest item of vegetation being cut to ensure optimum performance. A shape ratio of 0.3 is preferred for most applications.

The most effective shapes of the geometric fingers described herein provide a combination of chopping and slicing of the vegetation in order to provide a cleaner and more uniform cut which is desired with any rotary cutting machine application. There are several geometric shapes anticipated for effective use in the present invention that provide both a chopping and slicing action when cutting vegetation; however, other geometric shapes are contemplated herein that may not have both a chopping and a slicing action. As the vegetation impacts the geometric fingers during operation, a sinusoidal shape chops at its top edge and bottom edge and slices at its side edges between its top edge and its bottom edge. In a similar manner, a trapezoidal shape chops at the top edge and slices along its side edges. A spaced trapezoidal shape chops both at its top edge and at its spaced edge while maintaining a slicing action along its side edges. Triangular shaped geometric fingers maximize the slicing action along its side edges while minimizing the chopping action at its top edge that forms a point but the point creates an improved ability to penetrate more difficult vegetation. A spaced triangular shape improves the chopping function along the space edge while maintaining the slicing action along the side edges and the penetration improvement of the top edge. A circular shaped geometric finger is similar in function to a sinusoidal shaped geometric finger and chops along its top edge and its bottom edge while it slices at its side edges between the top edges and the bottom edges. The geometric fingers are anticipated to have various other shapes such as conic sections, like parabolas or hyperbolas, or any other shape that combines a chopping, penetrating and a slicing action. The geometric finger can be a combination of different shapes or can be constructed with a variable shape factor.

The front facing edge for the blade assembly and the integral blade, in addition to having geometric fingers, has a cutting angle relative to either the bottom side or the top side of the replaceable insert. The cutting angle is maintained between 20 degrees and 85 degrees for optimum performance. A cutting angle of 35 degrees is preferred for most applications. Angles are measured in a conventional counter clockwise manner, looking from one insert end with an insert installed toward the other end of the elongated blade or looking from one blade end of the integral blade toward the other end of the integral blade.

One or more stiffening ribs can be added to either the blade assembly or the integral blade to improve performance in heavier duty applications. As either the blade assembly or the integral blade rotates during operation, an imbalance or stress due to impacting vegetation can cause the elongated blade to flex. The addition of a stiffening rib will minimize any flexing that might occur. Too much flexing will generate vibration and cause additional wear on the rotary cutting machine and on the elongated blade.

One or more mulching blades can be added to either the blade assembly or to the integral blade to re-cut the vegetation that has been cut by the front facing edge. Mulching blades protrude above the top surface of the elongated blade at an angle greater than 20 degrees. The advantage to incorporating the mulching blades on either the blade assembly or the integral blade is that there is no need to collect the cut vegetation to achieve a cleanly cut appearance that is desirable in many applications wherein a rotary cutting machine is used. As the vegetation is re-cut into small pieces, it is evenly dispersed over the area being cut which further enhances vegetation growth as the cut vegetation decays.

In order to enhance the performance of the blade assembly or the integral blade, the trailing edge of the insert end or of the cutting end, respectively, forms a lift surface with the top surface that causes air flow which lifts the vegetation into the path of the rotating front facing edge. The lift surface acts as a fan blade drawing air from the area of the vegetation which creates a vacuum effect on the vegetation making it stand up to be cut by the rotating blade assembly or integral blade. The result is uniformly cut vegetation such as grass in a lawn where each blade of grass has the appearance of being cut uniformly.

The leading edge of the insert end on the blade assembly and the cutting edge on the integral blade are formed at a skew angle with the longitudinal axis. The skew angle changes the angle of attack for the front facing edge of the replaceable insert and the integral blade during operation. The skew angle adds a slicing action to any cutting edge and enhances the slicing action of the geometrically shaped fingers described above. The skew angle causes one section along the cutting edge to engage the vegetation prior to a second section engaging the vegetation relative to the direction that the rotary cutting machine advances over the vegetation which creates both a normal and a tangential component to the interaction between the front facing edge and the vegetation. The tangential component adds the slicing action to the path of the front facing edge as it passes through the vegetation being cut. The skew angle for best performance is between +15 degrees and −15 degrees relative to said longitudinal axis. A skew angle of 5 degrees is preferred for most applications. As stated above, angles are measured in a conventional counter clockwise manner, looking down on the top surface of the elongated blade.

The replaceable insert is attached to the insert end of the elongated blade for the blade assembly by one or more insert end fasteners. There are various means and methods for connecting the replaceable insert to an insert end as contemplated in this invention. Most obvious is a combination of one or more nuts and bolts. Through holes are aligned through both the replaceable insert and the insert end where a bolt is passed through and a nut is connected thereto to join the replaceable insert to the insert end. One or more gripper tabs on the replaceable insert that extend from the replaceable insert over an edge of the insert end can be used to reinforce the union of the replaceable insert and the insert end which minimizes relative movement between the replaceable insert and the insert end, particularly when a hard object is struck during operation.

In an alternate embodiment of the insert end fasteners, one or more fastener slots in the one or more insert ends is matingly located to receive one or more fastener tabs on the replaceable insert. The fastener tabs are inserted into the fastener slots and locked into place with a retainer spring by sliding the replaceable insert distally away from the central axis. A retention boss prevents the retainer spring from rotating during operation. One or more gripper tabs on the replaceable insert that extend from the replaceable insert over an edge of the insert end can be used to reinforce the union of the replaceable insert and the insert end which minimizes relative movement between the replaceable insert and the insert end, particularly when a hard object is struck during operation.

One embodiment of a safety connector in a blade assembly in the present invention, is a safety tab on a replaceable insert that engages a safety tab slot on an insert end. There are several embodiments of safety tabs on replaceable inserts that mating engage safety tab slots on insert ends that are contemplated in the present invention. For example, a safety tab on a replaceable insert is a flap perpendicular to the replaceable insert with a hook protruding from the top of the flap and extending distally such that when the safety tab is inserted into a safety tab slot on an insert end and the replaceable insert is shifted distally away from the central axis, the hook on the safety tab engages the safety tab slot on the insert end. The safety tab slot in the insert end has a front wall substantially parallel to the longitudinal axis, a back wall substantially parallel to the longitudinal axis, a proximal wall that is generally perpendicular to the longitudinal axis and extends between the front wall and the back wall and a distal wall formed to create a locking angle relative to the longitudinal axis and extending between the front wall and the back wall. The safety tab is designed to maintain the installation of the replaceable insert under centrifugal loading induced by the rotation of the blade assembly and has been included in the present invention to prevent the dislodging of the replaceable insert in the event that insert fasteners fail during operation and cause damage or injury as a result of the replaceable insert striking a person or thing. In the event that the insert fasteners fail in this example, the safety tab will engage the distal wall of the safety slot at the locking angle. The replaceable insert will be under centrifugal loading during operation which will cause the safety tab to migrate to a more distal position along the locking angle of the safety tab slot thereby creating a force that pulls the front facing edge of the replaceable insert toward the trailing edge of the insert end. As the safety tab pulls the replaceable insert toward the trailing edge, the gripper tabs will more tightly engage the leading edge of the insert end completely securing the replaceable insert to the insert end. The locking angle anticipated in this invention is between 30 degrees and 60 degrees relative to said longitudinal axis measured in a conventional counter clockwise manner, here looking down on the top surface of the elongated blade. A locking angle of 45 degrees is preferred in most applications.

### BRIEF DESCRIPTION OF THE DRAWINGS

A more complete understanding of the invention may be had by reference to the accompanying drawings in which:

FIG. 1 is a perspective view of the bottom of a rotary cutting machine according to this invention, showing blade assembly with an insert holder with a replaceable insert located at each end of an elongated blade.

FIG. 2 is a bottom view of a blade platform according to this invention, showing multiple blade assemblies with a single replaceable insert located at an insert end of an elongated blade.

FIG. 3 is a perspective view of an insert holder, for use with a replaceable insert (not shown) located at each end of an elongated blade, to be installed using bolts and having a stiffening rib.

FIG. 4 is a perspective view of a replaceable insert that uses nut and bolt combination as fasteners in cooperation with gripper tabs, having mulching blades and a safety tab.

FIG. 5 is a perspective view of a blade assembly with an insert holder, showing a replaceable insert located at each end of an elongated blade showing an added detail of one replaceable insert being completely installed using bolts in cooperation with gripper tabs as fasteners and the other replaceable insert being partially installed prior to bolts being installed.

FIG. 6 is a perspective view of a blade assembly with an insert holder having one insert end, showing a replaceable insert installed at the insert end of an elongated blade using bolts in cooperation with gripper tabs as fasteners and having mulching blades.

FIG. 7 is a perspective view of a blade assembly with an insert holder having one insert end, as viewed from below, showing a replaceable insert, indicating assembly order using bolts in cooperation with gripper tabs as fasteners.

FIG. 8 is a perspective view of a replaceable insert with a safety tab without mulching blades using bolts in cooperation with gripper tabs as fasteners.

FIG. 9 is a perspective view of an insert holder, for use with a replaceable insert (not shown) located at each end of an elongated blade, to be installed using fastener slots in cooperation with a replaceable insert having fasteners tabs without a stiffening rib.

FIG. 10 is a perspective view of a replaceable insert that uses fastener tabs in cooperation with gripper tabs and fastener slots in an insert end (not shown) as fasteners, having mulching blades and a safety tab.

FIG. 11 is a perspective view of a blade assembly with an insert holder, showing a replaceable insert located at each end of an elongated blade with the added detail of one replaceable insert being completely installed using fastener tabs in cooperation with gripper tabs and fastener slots on insert ends as fasteners and the other replaceable insert being partially installed showing the transition of the fastener tabs and the safety tab as they advance from first insertion to final installation.

FIG. 12 is a perspective view of a blade assembly with an insert holder having one insert end, showing a replaceable insert installed at the insert end of an elongated blade with fastener tabs acting in cooperation with fastener slots and gripper tabs as fasteners and having mulching blades.

FIG. 13 is a perspective view of a blade assembly with an insert holder having one insert end, as viewed from below, showing a replaceable insert, indicating assembly order using fastener tabs and fastener slots in cooperation with gripper tabs as fasteners.

FIG. 14 is a perspective view of a replaceable insert with a safety tab without mulching blades using fastener tabs and fastener slots (not shown) in cooperation with gripper tabs as fasteners.

FIG. 15 is a top view of a section of one embodiment of a shaped leading edge, a spaced trapezoid, on a replaceable insert, indicating the dimensional relation between the spacing distance, S, of each finger and the depth, D, of each finger.

FIGS. 16(a) through 16 (h) are perspective views of several embodiments of the shaped leading edge of the replaceable insert, showing various embodiments that are contemplated to be used as geometric fingers and defining the cutting angle formed, as shown, with the bottom face of the replaceable insert.

FIG. 17 is a perspective view of a replaceable insert with an alternate embodiment of a safety tab with mulching blades for use with nut and bolt combinations in cooperation with gripper tabs as fasteners.

FIG. 18 is a perspective view of an alternate embodiment of an insert holder and a replaceable insert with another alternate embodiment of a safety tab with mulching blades for use with nut and bolt combinations in cooperation with gripper tabs as fasteners.

FIG. 19 is a perspective view of an integral blade with a shaped leading edge installed at a skew angle and with a lift surface without mulching blades.

### DESCRIPTION OF THE PREFERRED EMBODIMENTS

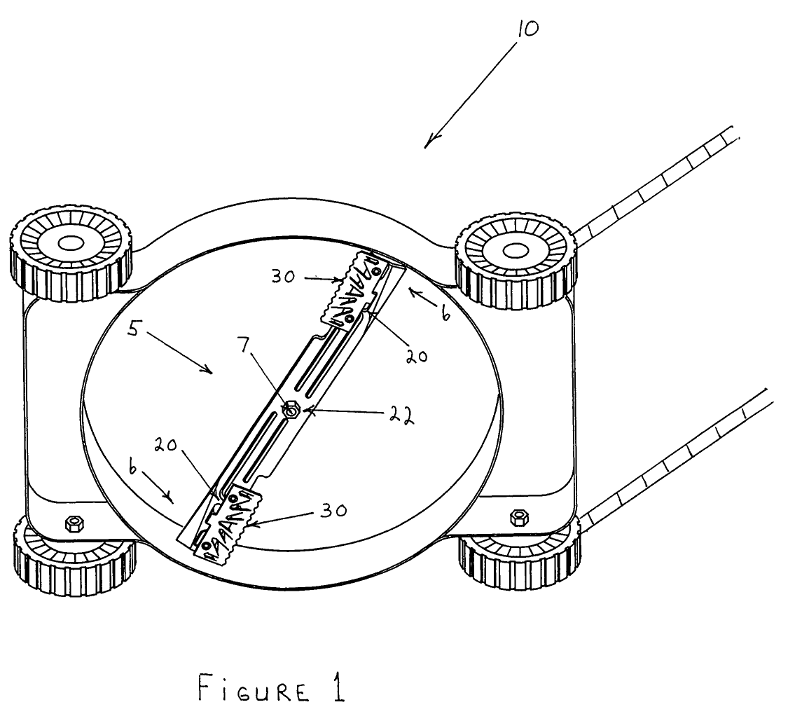

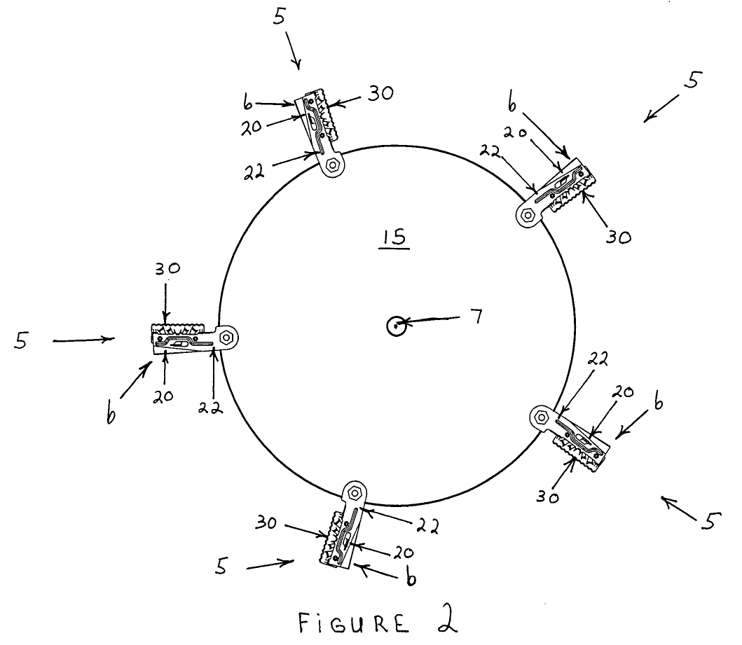

Referring now to the drawings wherein like reference numerals have been used throughout to designate like parts among the several views. Referring to FIG. 1 which shows a perspective view of the bottom of a rotary cutting machine 10 having a blade assembly 5 with an insert holder 20 located at each blade end 6 of elongated blade 22 each with a replaceable insert 30 that rotates about a central axis 7. In FIG. 2, blade platform 15 is shown with multiple blade assemblies 5, each having an elongated blade 22 with a single insert holder 20 and a replaceable insert 30 located at only one blade end 6 spaced around the circumference of blade platform 15 configured to rotate about central axis 7.

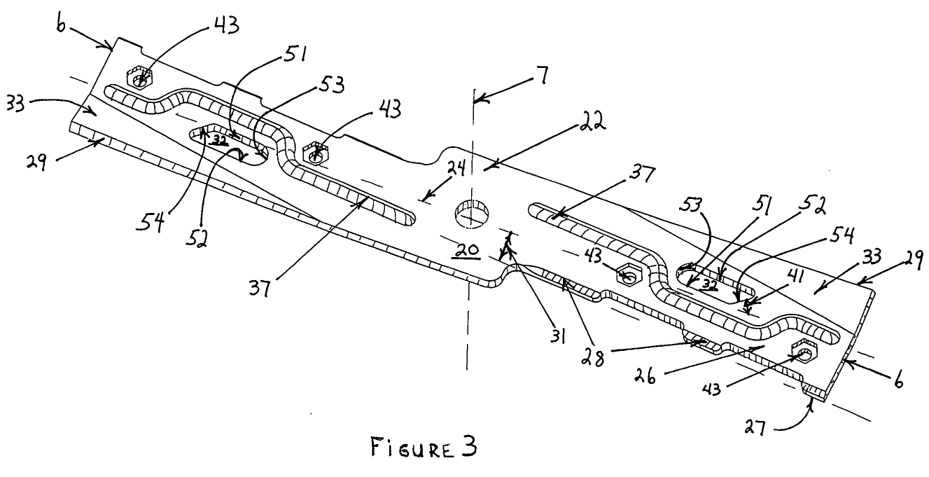

FIG. 3 is a perspective view of insert holder 20 prior to the installation of replaceable inserts 30 (not shown). Insert holder 20 consists of an elongated blade 22 that rotates about central axis 7. Longitudinal axis 24 extends beyond the length of insert holder 20 to define relative placement of elements of the present invention. Elongated blade 22, as shown, has two insert ends 25 located distally from central axis 7 at each blade end 6 of insert holder 20. Each insert end 25 has a top surface 26, bottom surface 27, trailing edge 29 and leading edge 28. Leading edge 28 is shaped to engage replaceable insert 30 (not shown). Blade holes 43 are located on insert end 25 to match up with similar holes in replaceable insert 30 (not shown). Leading edge 28 is formed at skew angle 31 relative to longitudinal axis 24. Skew angle 31 is maintained between +15 degrees and −15 degrees relative to longitudinal axis 24. Trailing edge 29 forms lift surface 33 with top surface 26. Lift surface 33 functions during operation to generate a vacuum on the vegetation being cut (not shown) so that a clean and accurate cut is achieved. In order to provide a stronger elongated blade 22, stiffening rib 37 is incorporated on insert holder 20. Additional stiffening ribs 37 can be incorporated if a more ridged blade is desired. Safety tab slot 32 is located to engage a safety tab 42 on replaceable insert 30 (not shown). Safety tab slot 32 has a front wall 51 that is generally parallel to longitudinal axis 24, a back wall 52 that is generally parallel to longitudinal axis 24, proximal wall 53 generally perpendicular to longitudinal axis 24 that extends between front wall 51 and back wall 52. Distal wall 54 extends between front wall 51 and back wall 52 at locking angle 41 relative to the longitudinal axis 24.

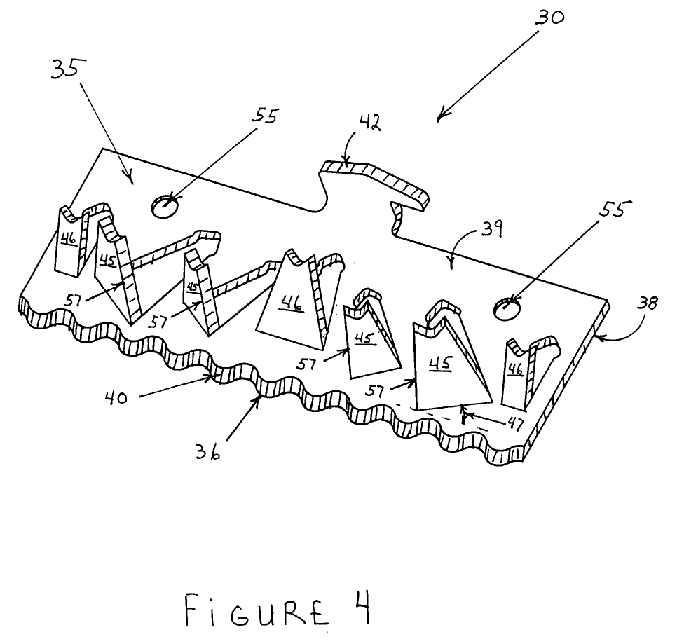

FIG. 4 is a perspective view of one preferred embodiment of replaceable insert 30. Replaceable insert 30 is a formed from a flattened blade 35. Flattened blade 35 has a front facing edge 36, a topside 39, a bottom side 38, a safety tab 42, mulching blades 45, gripper tabs 46 and insert holes 55. Front face edge 36 is comprised of a shaped leading edge 40. One embodiment of a preferred shaped leading edge is a sinusoidal shape as shown in FIG. 4. Mulching blades 45 protrude above top side 39. As shown a FIG. 4, mulching blades 45 are oriented relative to front facing edge 36 at mulching blade angle 47. Mulching blades 45 in other possible embodiments are arranged such that there is a mulching blade edge 57 oriented toward front facing edge 36 to re-cut vegetation (not shown) after being cut by shaped leading edge 40.

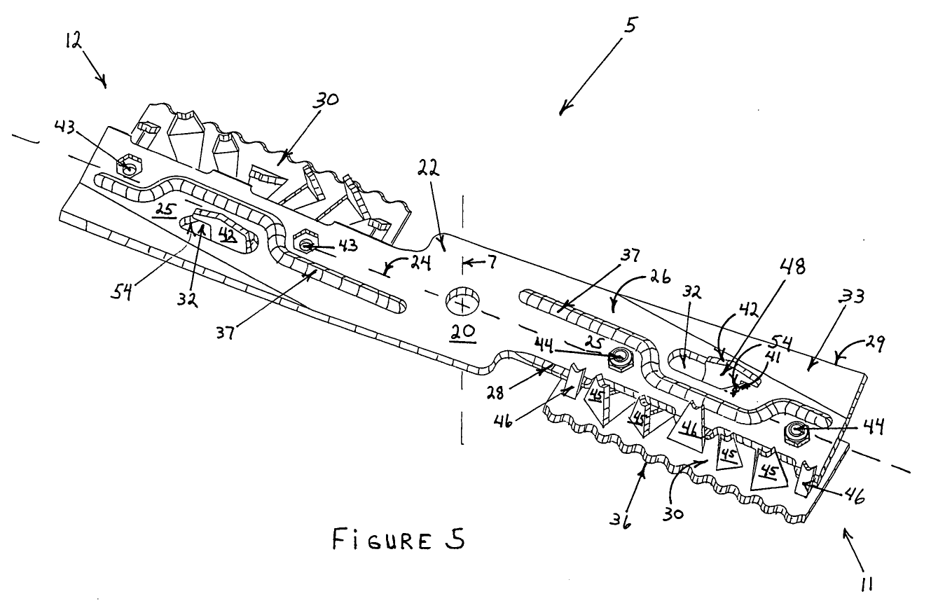

A perspective view of blade assembly 5 with two insert holders 20 on elongated blade 22 each with a replaceable insert 30 is shown in FIG. 5. Assembled end 11 shows replaceable insert 30 completely installed on insert end 25. Partially assembled end 12 shows replaceable insert 30 just prior to complete assembly with safety tab 42 inserted in safety tab slot 32. After inserting safety tab 42 in safety tab slot 32, replaceable insert 30 is shifted distally from central axis 7 causing safety tab 42 to engage distal wall 54 and causes blade holes 43 to align with insert holes 55 (not shown) in replaceable insert 30. At assembled end 11, safety tab 42 has been inserted in safety tab slot 32 and adjusted to engagement position 48. Nut and bolt combinations 44 securely fasten replaceable insert 30 to insert end 25. Gripper tabs 46 engage leading edge 28 to further secure replaceable insert 30 to insert end 25. In the event that nut and bolt combination 44 fails, safety tab 42 will be forced against distal wall 54 through centrifugal force and further cause gripper tabs 46 to be drawn tightly against leading edge 28 as it migrates along locking angle 41, thereby preventing replaceable insert 30 from becoming dislodged from insert end 25. Trailing edge 29 forms lift surface 33 with top surface 26. Lift surface 33 functions during operation to generate a vacuum on the vegetation being cut (not shown) so that a clean and accurate cut is achieved. In order to provide a stronger elongated blade 22, stiffening rib 37 is incorporated on insert holder 20. Additional stiffening ribs 37 can be incorporated if a more ridged blade is desired. Mulching blades 45 re-cut the vegetation that has been cut by the front facing edge 36. Mulching blades 45 protrude above the top surface 26 of elongated blade 22.

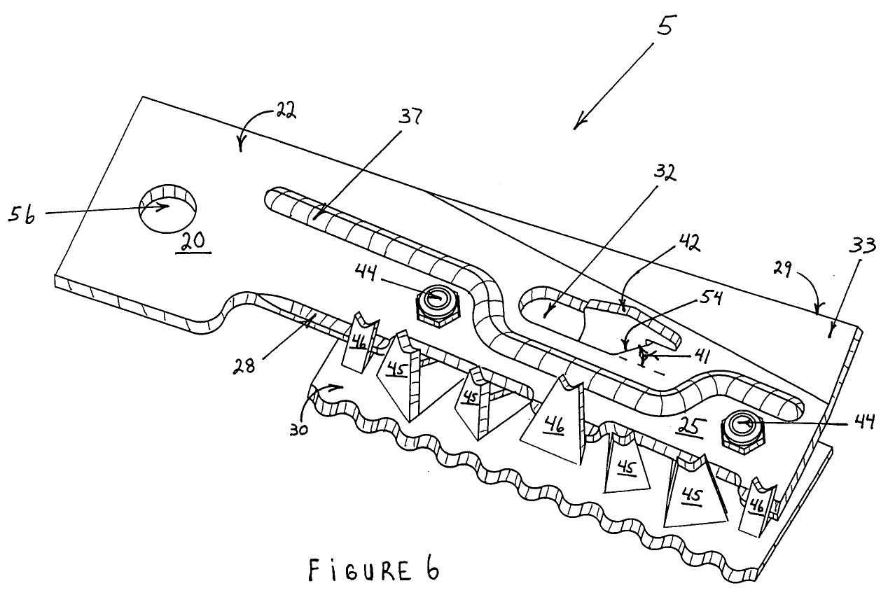

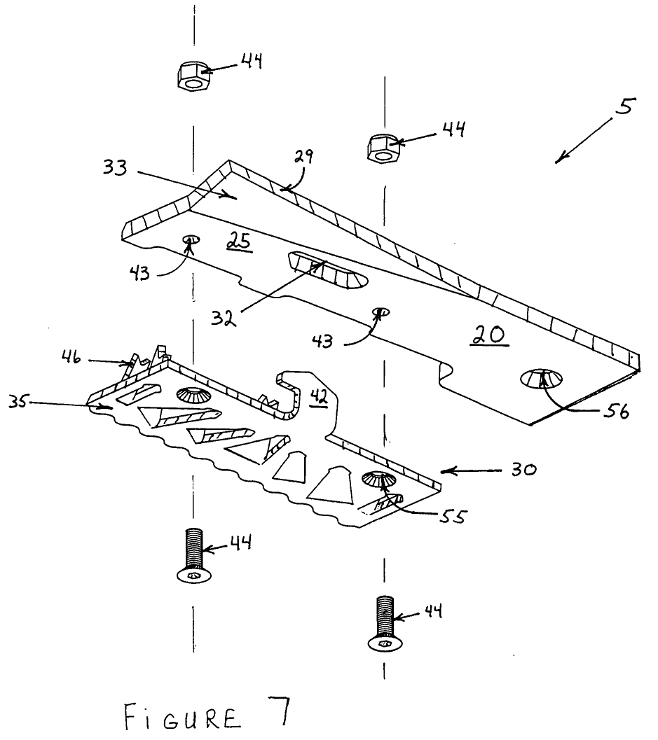

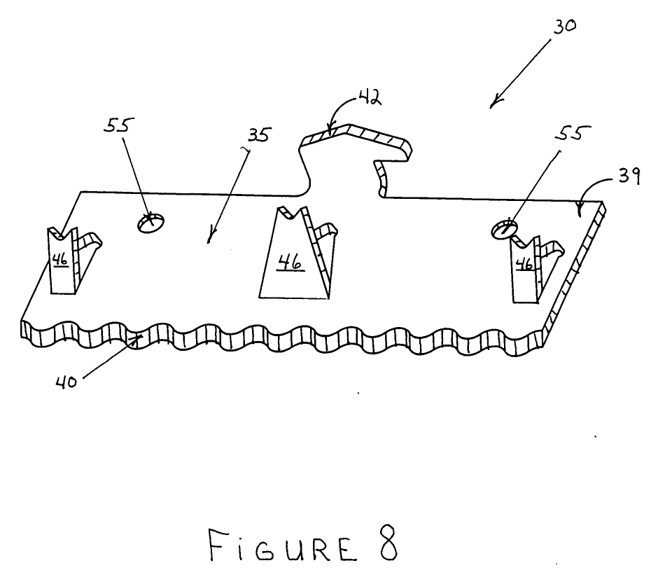

FIG. 6 shows a perspective view of blade assembly 5 with replaceable insert 30 installed on insert holder 20, as was described in FIG. 5, but only at only one insert end 25. Insert holder 20 is contemplated to be used with a blade platform 15 as shown in FIG. 2. Insert holder 20 is attached to blade platform 15 (not shown) at pin hole 56. FIG. 7 is a perspective view of blade assembly 5 with insert holder 20 with a replaceable insert 30 as shown in FIG. 6 prior to assembly. Nut and bolt combination 44 aligns insert holes 55 with blade holes 43 as safety tab 42 is inserted in safety tab slot 32 and shifted distally from pin hole 56. FIG. 8 is a perspective view of an alternate embodiment of replaceable insert 30 without mulching blades 45 as shown in FIG. 4. Replaceable insert 30 has insert holes 55 for use with nut and bolt combination 44 (not shown) to attach replaceable insert 30 to insert end 25 (not shown).

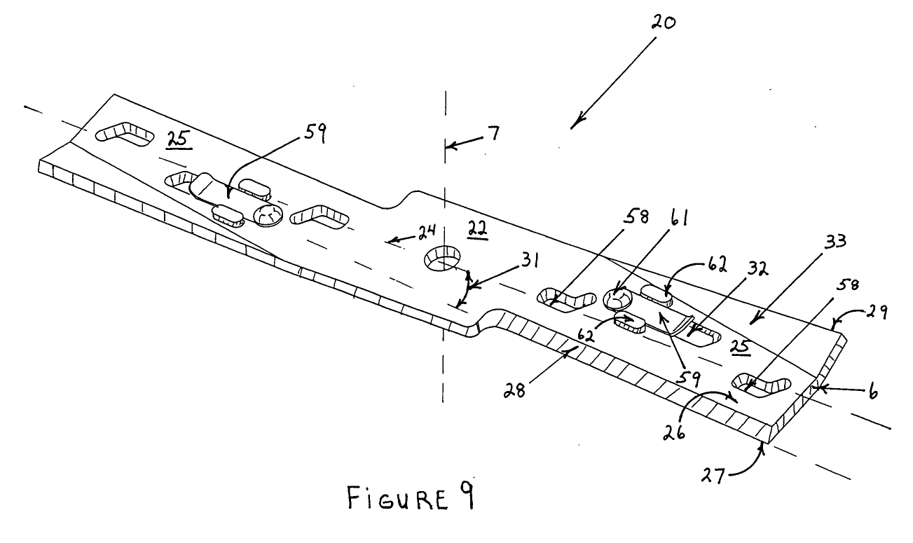

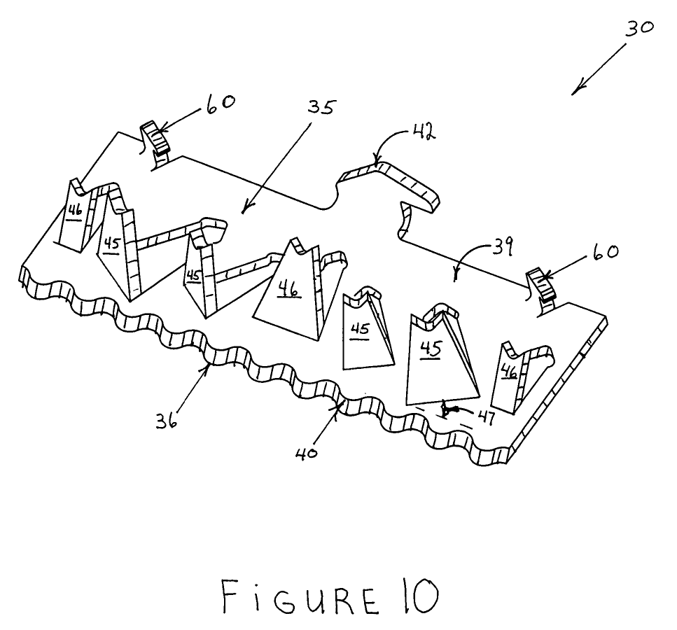

An alternate embodiment of insert holder 20 is shown in perspective view in FIG. 9. Insert holder 20 is shown with two insert ends 25 such that during operation it will rotate about central axis 7 that passes through a midpoint of insert holder 20. In this embodiment, no stiffening rib 37 is shown as was shown in FIG. 3 but is also contemplated for this embodiment. Leading edge 28 is a simple chamfered edge as shown. In FIG. 9, fastener slots 58 replace blade holes 43 and insert holes 55 as shown in FIG. 3 and FIG. 4, respectively. Retainer spring 59 is attached to insert end 25 by retention fastener 61. Retention boss 62 prevents retainer spring 59 from rotating during operation. All other features of insert holder 20 as described in FIG. 3 are equally contemplated for insert holder 20 as shown in FIG. 9. FIG. 10 is a alternate embodiment of replaceable insert 30 as was shown in FIG. 4 with fastener tabs 60 that engage fastener slots 58 on alternate embodiment of insert holder 20 shown in FIG. 9 and replace nut and bolt combination 44 as shown in FIG. 5.

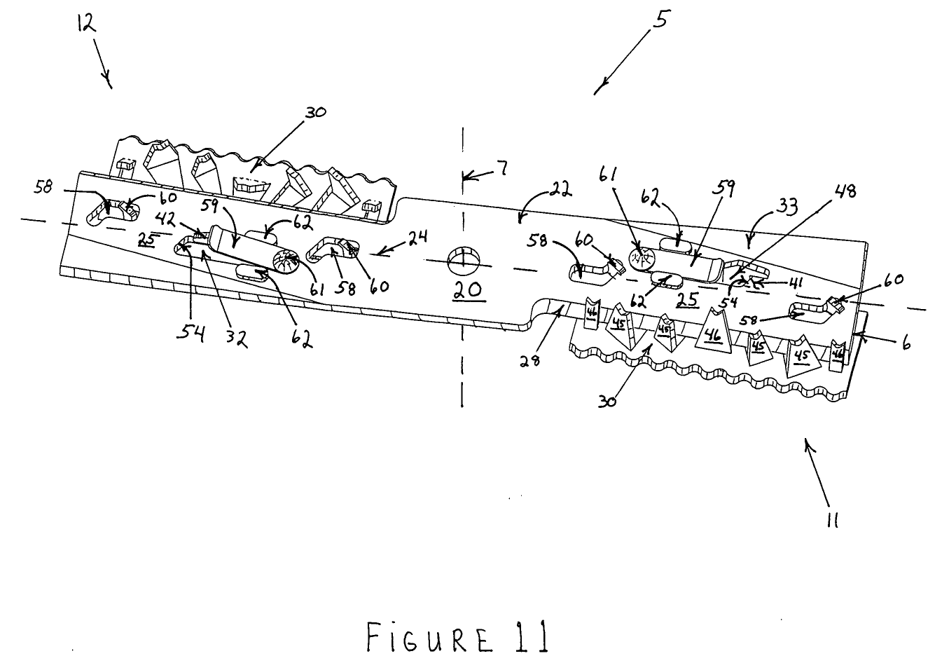

A perspective view of an alternate embodiment of blade assembly 5 with two insert holders 20 with replaceable inserts 30 with fastener tabs 60 is shown in FIG. 11. Assembled end 11 shows replaceable insert 30 completely installed on insert end 25. Partially assembled end 12 shows replaceable insert 30 just prior to complete assembly with safety tab 42 inserted in safety tab slot 32 and fastener tabs 60 inserted in fastener slots 58. Retainer spring 59 is moved under spring tension to permit safety tab 42 to be inserted into safety tab slot 32. After inserting safety tab 42 in safety tab slot 32 and fastener tabs 60 into fastener slots 58, replaceable insert 30 is shifted distally from central axis 7 causing safety tab 42 to engage distal wall 54 and causes fastener tabs 60 to engage fastener slots 58 in replaceable insert 30. Referring now to assembled end 11, safety tab 42 has been inserted in safety tab slot 32 and adjusted to engagement position 48. Retainer spring 59 closes behind safety tab 42 as safety tab 42 engages distal wall 54, retainer spring 59 holds safety tab 42 at engagement position 48 during operation. Retainer bosses 62 keeps retainer spring 59 from rotating about retention fastener 61 during operation. Gripper tabs 46 engage leading edge 28 to further secure replaceable insert 30 to insert end 25. During operation, safety tab 42 and fastener tabs 60 will engage safety tab slot 32 and fastener slots 58, respectively, through centrifugal force and further cause gripper tabs 46 to be drawn tightly against leading edge 28 as safety tab 42 slides along locking angle 41, thereby securely connecting replaceable insert 30 to insert end 25. Fastener tabs 60 and fastener slots 58 are the main means to connect replaceable insert 30 to insert end 25. Safety tab 42 in cooperation with safety tab slot 32 provide a back up means to ensure that replaceable insert 30 does not become dislodged from insert holder 20 in the event that fastener tabs 60 fail.

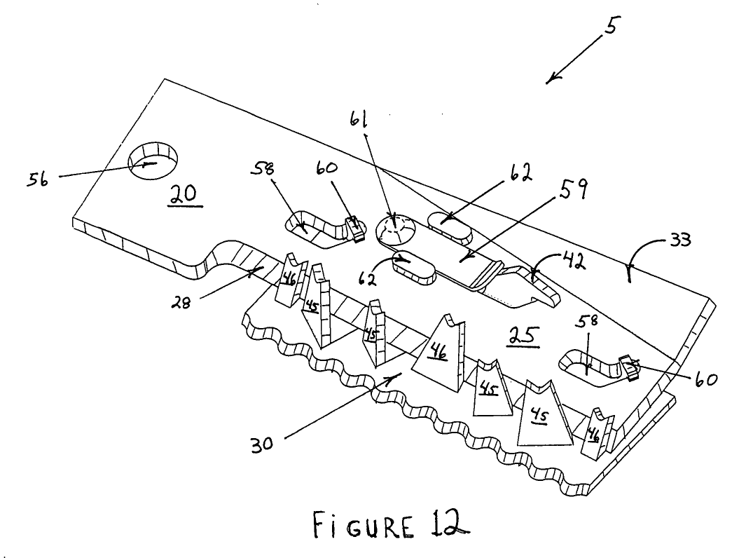

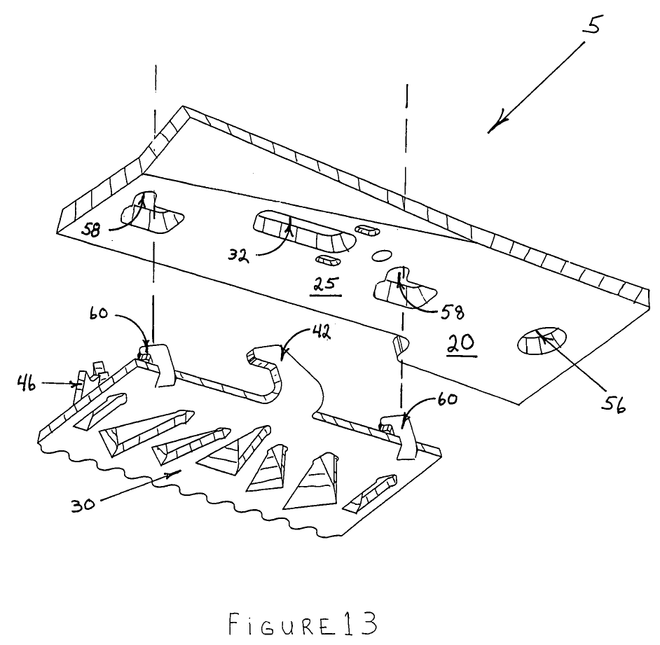

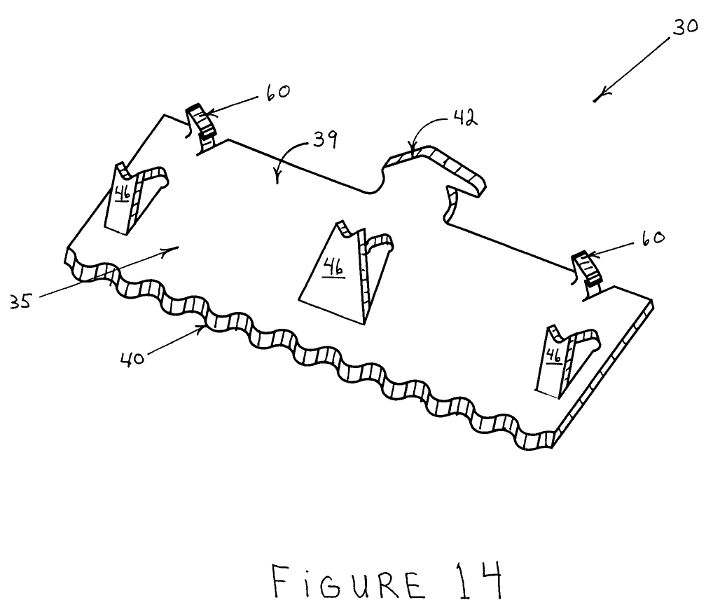

FIG. 12, is a perspective view of an alternate embodiment of blade assembly 5 with replaceable insert 30 installed on insert holder 20, as was described in FIG. 11, but only at one insert end 25 with fastener tabs slots 58. Insert holder 20 is contemplated to be used with a blade platform 15 as shown in FIG. 2. Insert holder 20 is attached to blade platform 15, shown in FIG. 2, at pin hole 56. FIG. 13 is a perspective view of an alternate embodiment of insert holder 20 with replaceable insert 30 from FIG. 12 prior to assembly. Fastener tabs 60 and safety tabs 42 are shown prior to assembly as safety tab 42 and fastener tabs 60 are inserted in safety tab slot 32 and fastener slots 58, respectively. FIG. 14 is a perspective view of an alternate embodiment of replaceable insert 30 with fastener tabs 60 and without mulching blades 45 as shown in FIG. 10.

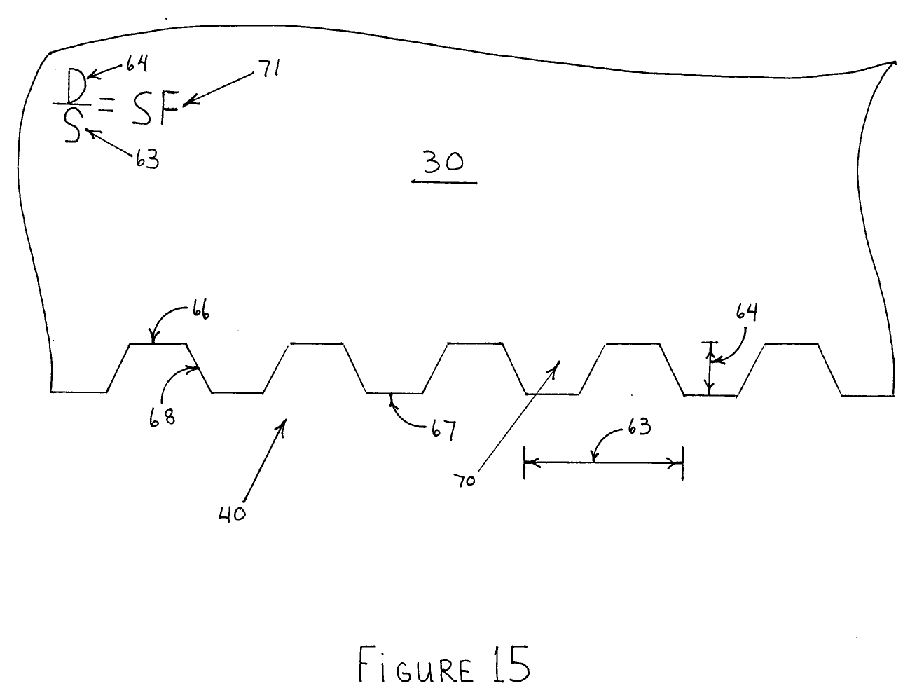

FIG. 15 (not to scale) is a top view of a section of shaped leading edge 40 of replaceable insert 30 (not shown in its entirety) defining spacing distance 63 and depth 64 of geometric fingers 70. Shaped leading edge 40 has a plurality of geometric shaped fingers 70. A spaced trapezoidal shape is shown in FIG. 15 for illustration purposes; however, other shapes are equally contemplated and will be described herein. Spacing distance (S) 63 is the distance between equivalent points along shaped leading edge 40. Depth (D) 64 is the distance from top edge 67 of a geometric finger 70 to spaced edge 66, as shown here, or to an equivalent point at the base of a geometric finger 70 that may not have a spaced edge 66 as will be described below. The ratio of depth 64 divided by spacing distance 63 defines a shape ratio (SR) 71. The shape ratio 71 is held to values between zero (0.00) and 1.00 for best performance. Optimally the shape ratio is 0.3. During cutting operation, top edge 67 and spaced edge 66 chop the vegetation while side edge 68 slices the vegetation. The combination of chopping and slicing the vegetation provide a more accurate and effective cut which is an object of this invention.

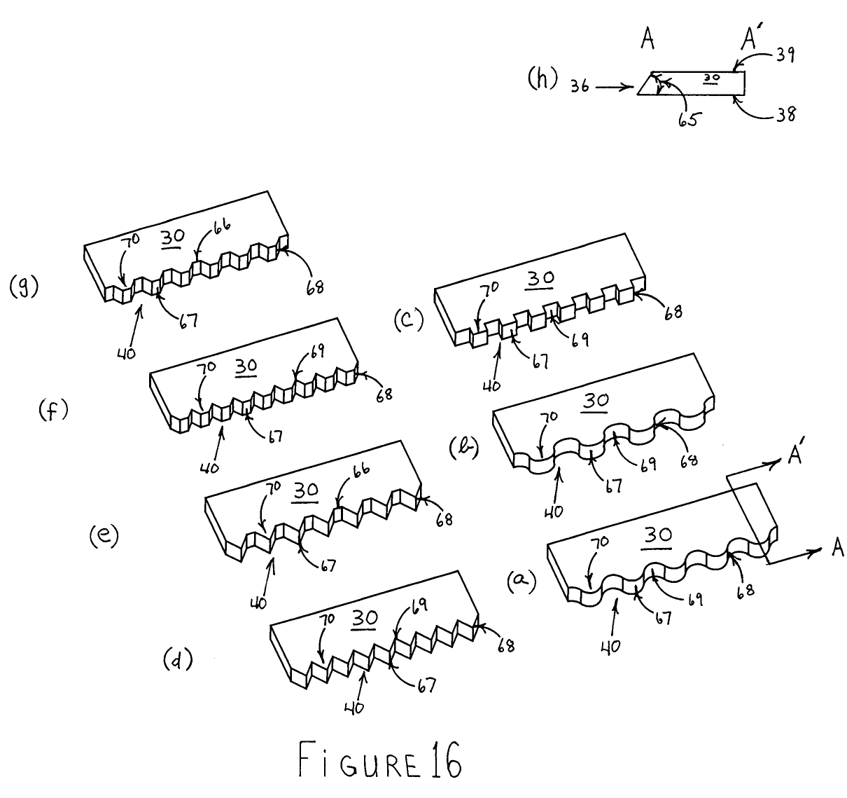

FIG. 16(a) through 16(g) show a perspective view of various embodiments of shaped leading edge 40. Each embodiment shown provides a cleaner and more uniform cut for various cutting applications which is desired with any rotary cutting machine. As the vegetation impacts the geometric fingers 70 during operation, a sinusoidal shape shown in FIG. 16(a) chops at its top edge 67 and bottom edge 69 and slices at its side edges 68. A circular shaped geometric finger 70 shown in FIG. 16(b) is similar in function to a sinusoidal shaped geometric finger 70 shown in FIG. 16(a) since the top edge 67 and bottom edge 69 chop and the side edge 68 slice vegetation. A rectangular shaped geometric finger 70 as shown in FIG. 16(c) is better suited for tougher cutting applications such as fields where saplings might be cut because there is only a chopping function that is accomplished by top edge 67 and spaced edge 66. FIGS. 16(d) and 16(e) show two embodiments of triangular shaped geometric fingers 70. In FIG. 16(d), top edge 67 is a point that provides improved penetration but no chopping function while still providing a slicing function with its side edges 68. The chopping function is added in the spaced triangular shape of FIG. 16(e), where spaced edge 66 provides a chop edge. In a similar manner as shown in FIGS. 16(f) and FIG. 16(g), both trapezoidal shapes chop at top edge 67 and slice at side edges 68. Spaced trapezoidal shape shown in FIG. 16(g) has an additional chop edge at spaced edge 66 that is not present in the trapezoidal shape in FIG. 16(f). Geometric fingers 70 are anticipated to have various other shapes such as conic sections, like parabolas or hyperbolas or any other shape, in particular any shape that combines a chopping or penetrating and a slicing action. The cross section A-A′ of front facing edge 36 is shown in FIG. 16 (h) and has a cutting angle 65 relative to either the bottom side 38 or the top side 39 of replaceable insert 30 and is common among all embodiments of shaped leading edge 40. For optimum performance, cutting angle 65 is maintained between 20 degrees and 85 degrees. A cutting angle 65 of 35 degrees is preferred for most applications. Angles are measured in a conventional counter clockwise manner, looking from one end of replaceable insert 30 toward the other end of the replaceable insert 30.

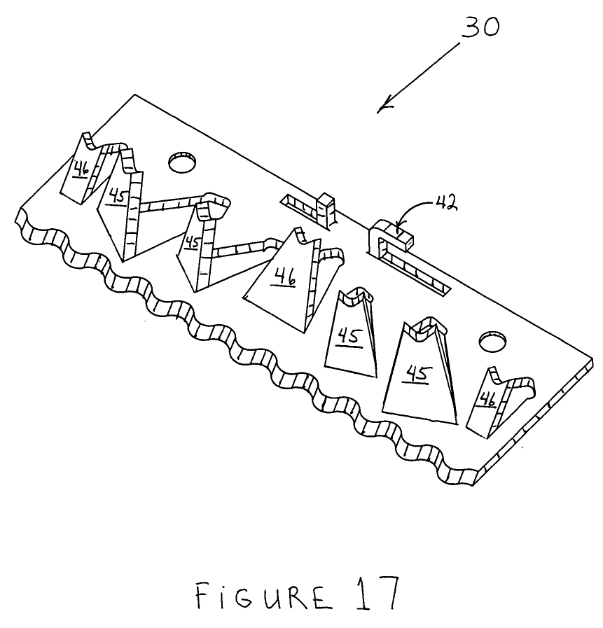

FIG. 17 shows a perspective view of an alternate embodiment of replaceable insert 30 shown in FIG. 4 for use on insert end 25 shown in FIG. 3. Safety tab 42 in FIG. 17 is constructed differently but is installed and functions in the same manner as the safety tab 42 from FIG. 4 without changing safety tab slot 32 in FIG. 3.

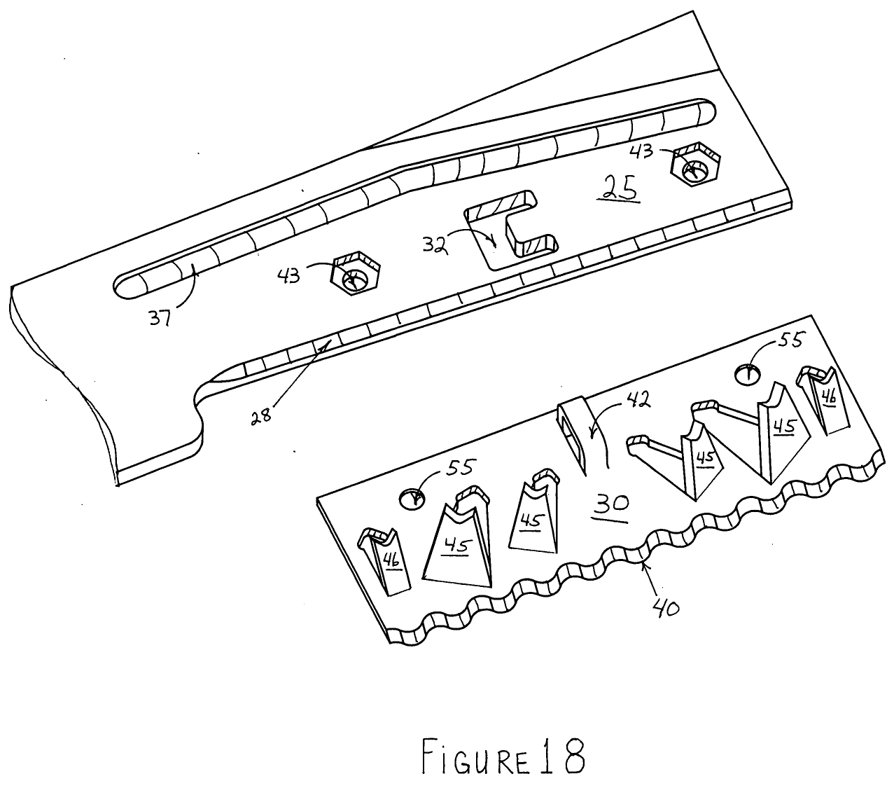

FIG. 18 shows a perspective view of and alternate embodiment of insert end 25 as shown in FIG. 3 and replaceable insert 30 as shown in FIG. 4. Insert end 25 in FIG. 18 has a different configuration for safety tab slot 32 and is constructed to receive the alternate embodiment of safety tab 42 on replaceable insert 30. Both embodiments function in a similar manner, safety tab 42 is inserted into safety tab slot 32 on insert end 25 and shifted distally to align insert holes 55 with blade holes 43 for assembly. In the event fastener failure, centrifugal force will act to engage safety tab 42 with safety tab slot 32 to prevent dislodging of replaceable insert 30.

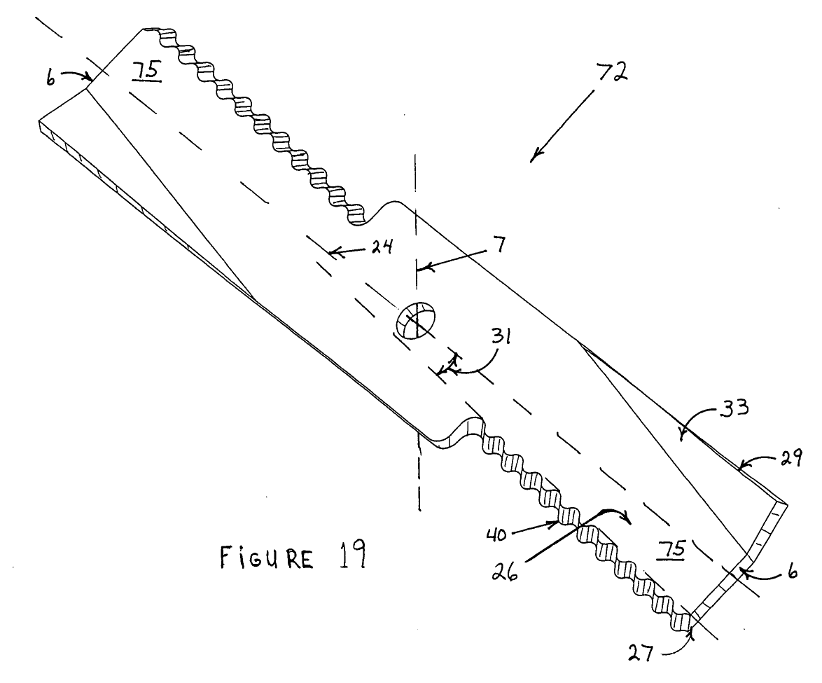

Integral blade 72 is shown in perspective view in FIG. 19 with two blade ends 6 each configured with a cutting end 75. Each cutting end 75 has an embodiment of a shaped leading edge 40 as shown in FIGS. 16 (a) through 16(h). In similar manner to the leading edge 28 of FIG. 3, shaped leading edge 40 is formed at a skew angle 31 relative to longitudinal axis 24. Each cutting end 75 has a top surface 26, bottom surface 27, trailing edge 29 and shaped leading edge 40. Skew angle 31 is maintained between +15 degrees and −15 degrees relative to longitudinal axis 24. A skew angle 31 of 5 degrees is optimum for most applications. Trailing edge 29 forms lift surface 33 with top surface 26. Lift surface 33 functions during operation to generate a vacuum on the vegetation being cut (not shown) so that a clean and accurate cut is achieved. In order to provide a stronger integral blade 72, a stiffening rib 37, as shown in FIG. 3, can be added to integral blade 72 to improve performance for heavier duty applications. Mulching blades 45 (not shown) are also contemplated for an alternate embodiment of the integral blade 72.

It is to be understood that the present invention is not limited to the embodiments described above, but encompasses any and all embodiments within the scope of the following claims.

I claim:

1. A blade assembly for cutting vegetation in a rotary cutting machine comprising:
an insert holder that comprises:
an elongated blade with two blade ends, having a longitudinal axis extending beyond the length of said elongated blade and adapted to rotate about a central axis;
one or more insert ends located at one or more of said blade ends, wherein each of said insert ends is configured to receive a replaceable insert, wherein each of said one or more insert ends comprises:
a top surface facing away from said vegetation;
a bottom surface facing toward said vegetation;
a leading edge formed to receive said replaceable insert;
a trailing edge;
one or more insert end fasteners for attaching said replaceable insert to said one or more insert ends;
a safety connector;
wherein said replaceable insert comprises:
a flattened blade adapted to mate with said one or more insert ends, having;
a bottom side;
a top side;
a rear facing edge;
a front facing edge for cutting said vegetation;
an insert safety connector that engages said safety connector on said one or more insert ends; and
one or more insert fasteners that matingly engages said one or more insert end fasteners on each of said one or more insert ends.

2. A blade assembly as described in claim 1 wherein said front facing edge comprises a shaped leading edge.

3. A blade assembly as described in claim 1 wherein said elongated blade further comprises one or more stiffening ribs.

4. A blade assembly as described in claim 1 wherein said blade assembly further comprises one or more mulching blades.

5. A blade assembly as described in claim 1 wherein said trailing edge forms a lift surface with said top surface.

6. A blade assembly as described in claim 1 wherein said leading edge is formed at a skew angle with said longitudinal axis.

7. A blade assembly as described in claim 1 wherein said one or more insert end fasteners comprise one or more fastener slots in said one or more insert ends matingly located to receive one or more fastener tabs on said replaceable insert; and one or more gripper tabs on said replaceable insert.

8. A blade assembly as described in claim 2 wherein said shaped leading edge comprises a plurality of geometric fingers along said shaped leading edge, each having a spacing distance, S, apart and each having a depth, D, wherein D divided by S is a shape ratio that is between zero (0.00) and one (1.00); and a cutting angle that is between 20 degrees and 85 degrees.

9. An integral blade for cutting vegetation in a rotary cutting machine comprising:
an elongated blade with two blade ends, having a longitudinal axis extending beyond the length of said elongated blade and adapted to rotate about a central axis;
wherein one or more of said blade ends is formed into a cutting end that comprises:
a top surface facing away from said vegetation;
a bottom surface facing toward said vegetation;
a shaped leading edge for cutting said vegetation; and
a trailing edge.

10. An integral blade as described in claim 9 wherein said elongated blade further comprises one or more stiffening ribs.

11. An integral blade as described in claim 9 wherein said elongated blade further comprises one or more mulching blades.

12. An integral blade as described in claim 9 wherein said shaped leading edge is formed at a skew angle with said longitudinal axis.

13. An integral blade as described in claim 9 wherein said trailing edge forms a lift surface with said top surface.

14. An integral blade as described in claim 9 wherein said shaped leading edge comprises a plurality of geometric fingers along said shaped leading edge, each having a spacing distance, S, apart and each having a depth, D, wherein D divided by S is a shape ratio that is between zero (0.00) and one (1.00); and a cutting angle that is between 20 degrees and 85 degrees.

15. An insert holder for use with a replaceable insert for cutting vegetation in a rotary cutting machine comprising:
an elongated blade with two blade ends, having a longitudinal axis extending beyond the length of said elongated blade and adapted to rotate about a central axis;
one or more insert ends located at one or more of said blade ends, wherein each of said insert ends is configured to receive said replaceable insert, wherein each of said one or more insert ends comprises:
a top surface facing away from said vegetation;
a bottom surface facing toward said vegetation;
a leading edge formed to receive said replaceable insert;
a trailing edge; and
a safety connector.

16. An insert holder for use with a replaceable insert for cutting vegetation in a rotary cutting machine as described in claim 15 wherein said leading edge is formed at a skew angle with said longitudinal axis.

17. An insert holder for use with a replaceable insert for cutting vegetation in a rotary cutting machine as described in claim 15 wherein said trailing edge forms a lift surface with said top surface.

18. An insert holder for use with a replaceable insert for cutting vegetation in a rotary cutting machine as described in claim 15 wherein said elongated blade comprises one or more mulching blades.

19. A replaceable insert for use with an insert holder for cutting vegetation in a rotary cutting machine comprising:
a flattened blade adapted to mate with said insert holder, having;
a bottom side;
a top side;
a rear facing edge;
a shaped leading edge for cutting said vegetation;
a insert safety connector that engages a safety connector on said insert holder; and
one or more insert fasteners that matingly engages one or more insert end fasteners on said insert holder.

20. A replaceable insert as described in claim 19 wherein said shaped leading edge comprises a plurality of geometric fingers along said shaped leading edge, each having a spacing distance, S, apart and each having a depth, D, wherein D divided by S is a shape ratio that is between zero (0.00) and one (1.00); and a cutting angle that is between 20 degrees and 85 degrees.

21. A replaceable insert as described in claim 20 wherein said geometric fingers comprise a sinusoidal shape.

22. A replaceable insert as described in claim 20 wherein said geometric fingers comprise a trapezoidal shape.

23. A replaceable insert as described in claim 20 wherein said geometric fingers comprise a triangular shape.

24. A replaceable insert as described in claim 20 wherein said geometric fingers comprise a circular shape.

25. A replaceable insert as described in claim 20 wherein said geometric fingers comprise a shape of a conic section.

26. A replaceable insert as described in claim 19 wherein said replaceable insert further comprises one or more mulching blades.
